(19) United States
(12) Patent Application Publication
(10) Pub. No.: US 2026/0299922 A1
(43) Pub. Date: Oct. 1, 2026

(54) Upgrade Management in a Resource-Constrained Environment

(71) Applicant: Oracle International Corporation, Redwood Shores, CA (US)

(72) Inventors: Andrei Gabriel Serban, Bucharest (RO); Sebastian Jürgen Hans, Berlin (DE); Marius Emanuel Popa, Bucharest (RO)

(73) Assignee: Oracle International Corporation, Redwood Shores, CA (US)

(21) Appl. No.: 19/283,907

(22) Filed: Jul. 29, 2025

Related U.S. Application Data
(60) Provisional application No. 63/780,071, filed on Mar. 28, 2025.

(51) Int. Cl. G06F 8/65

(52) U.S. Cl. CPC G06F 8/65

(57) ABSTRACT

Techniques are disclosed for upgrading an old version of an executable load file deployed on a secure element hardware platform into a new version of the executable load file while retaining static resources from the old version of the executable load file in the memory of the secure element hardware platform. The system identifies static resources from the old version of the executable load file to save in memory based on (a) instructions in an upgrade command that control the upgrade process and/or (b) requests by application instances derived from the old version of the executable load file. Unsaved resources from the old version of the executable load file are discarded, and the new version of the executable load file is deployed onto the secure element hardware platform. The static resources of the old executable load file are then selectively restored to the new version of the executable load file.

### INCORPORATION BY REFERENCE; DISCLAIMER

Each of the following applications are hereby incorporated by reference: Application No. 63/780,071 filed on Mar. 28, 2025. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to resource-constrained environments. In particular, the present disclosure relates to upgrading resources that are deployed on resource-constrained environments.

### BACKGROUND

As used herein, the term “resource-constrained environment” refers to a computing environment that possesses relatively limited computing resources. For example, a resource-constrained environment may possess comparatively fewer memory and/or processing resources than some other computing environments. A secure element hardware platform is one example of a resource-constrained environment. Due to the limitations of resource-constrained environments, software intended for a resource-constrained environment may be optimized to reduce the size and/or complexity of the software. As used herein, the term “executable load file” refers to software that is configured for a resource-constrained environment such as a secure element hardware platform. An example executable load file includes executable instructions, such as application logic or libraries, configured for execution by a virtual machine running on a secure element hardware platform.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating a computer system suitable for implementing methods and features described herein in accordance with one or more embodiments;

FIG. 3 illustrates an example virtual machine memory layout in block diagram form in accordance with one or more embodiments;

FIG. 4 illustrates an example frame in block diagram form in accordance with one or more embodiments;

FIG. 5 illustrates an example architecture for upgrading an executable load file in accordance with one or more embodiments;

FIG. 6 illustrates an example set of operations for upgrading an executable load file in accordance with one or more embodiments;

FIG. 7A illustrates operations of an example upgrade process for an executable load file that is deployed on a secure element hardware platform in accordance with an example embodiment;

FIG. 7B illustrates a secure element hardware platform at the beginning of an example saving phase of an example upgrade process in accordance with an example embodiment;

FIG. 7C illustrates a secure element hardware platform at the beginning of an example loading phase of an example upgrade process in accordance with an example embodiment;

FIG. 7D illustrates a secure element hardware platform at the time an example restore phase of an example upgrade process is concluded in accordance with an example embodiment;

FIG. 8A illustrates operations of an example upgrade process for an executable load file that is deployed on a secure element hardware platform in accordance with an example embodiment;

FIG. 8B illustrates a secure element hardware platform at the beginning of an example saving phase of an example upgrade process in accordance with an example embodiment;

FIG. 8C illustrates a secure element hardware platform at the beginning of an example saving phase of an example upgrade process in accordance with an example embodiment;

FIG. 8D illustrates a secure element hardware platform at the time an example restore phase of an example upgrade process is concluded in accordance with an example embodiment; and

FIG. 9 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. UPGRADE ARCHITECTURE
4. UPGRADING AN EXECUTABLE LOAD FILE
5. EXAMPLE EMBODIMENTS
   5.1 UPGRADING STATIC RESOURCES AND EXECUTABLE INSTRUCTIONS
   5.2 UPGRADING STATIC RESOURCES
6. HARDWARE OVERVIEW
7. MISCELLANEOUS; EXTENSIONS

### 1. GENERAL OVERVIEW

While upgrading an executable load file that is deployed on a secure element hardware platform from an old version to a new version, one or more embodiments selectively save static resources from the old version of the executable load file in the memory of the secure element hardware platform and then selectively restore these static resources to the new version of the executable load file that is deployed onto the secure element hardware platform during the upgrade process. As used herein, the term “static resource” refers to a sequence of binary data included in an executable load file that may be relied upon by executable instructions, such as application logic or libraries, during runtime. For example, after an executable load file is deployed onto a secure element hardware platform, an application instance derived from the executable load file may refer to a static resource included in the executable load file for non-executable, read-only data that is needed to perform some task. Historically, upgrading an executable load file deployed on a secure element hardware platform has entailed deleting any static resources included in an old version of the executable load file from the memory of the secure element hardware platform before deploying a new version of the executable load file onto the secure element hardware platform. This has been the case even where an upgrade process updates no static resources of an executable load file or a subset of the static resources that are included in the executable load file. In the context of an execution environment with scant memory and/or processing resources (i.e., a resource-constrained environment such as a secure element hardware platform), needlessly deleting, loading, and storing static resources during an upgrade process may be resource intensive. By selectively saving static resources of an old version of an executable load file in the memory of a secure element hardware platform and by selectively restoring these static resources to a new version of the executable load file that is deployed onto the secure element hardware platform, the system improves the efficiency of an upgrade process for the executable load file.

One or more embodiments identify static resources included in an old version of an executable load file that should be retained in memory of a secure element hardware platform for at least part of an upgrade process (i.e., “saved”) based on (a) instructions included in an upgrade command that specifies parameters for the upgrade process and/or (b) requests by application instances derived from the old version of the executable load file that are running on the secure element hardware platform at the outset of the upgrade process. These static resources from the old version of the executable load file are saved during the upgrade process, so these static resources can be included with a new version of the executable load file (i.e., “restored”) that is deployed on the secure element hardware platform during the upgrade process as needed. Note that during the upgrade process, one static resource may be saved pursuant to instructions in the upgrade command, and another static resource may be saved pursuant to a request by an application instance. It should also be noted that a static resource from the old version of the executable load file that is saved during the upgrade process is not necessarily restored to the new version of the executable load file. Additionally, or alternatively, the system identifies saved static resources from the old version of the executable load file that should be restored to the new version of the executable load file based on (a) instructions included in the upgrade command and/or (b) requests by application instances derived from the new version of the executable load file that are initialized on the secure element hardware platform in the course of the upgrade process. Note that during the upgrade process, one saved static resource may be restored pursuant to instructions in the upgrade command, and another static resource may be restored pursuant to a request by an application instance.

One or more embodiments generate an upgrade command that includes instructions for saving static resources included in an old version of an executable load file during an upgrade process for the executable load file. For instance, prior to initiating the upgrade process, the system may determine that certain static resources included in the old version of the executable load file should be saved during the upgrade process, so these static resources can be restored to the new version of the executable load file if needed. Based on this determination, the system may generate an upgrade command that includes instructions for saving these static resources. These instructions may be encoded into a special parameter that is added to the upgrade command by the system for this purpose. The system then transmits the upgrade command to the secure element hardware platform to initiate the upgrade process. After receiving the upgrade command, a runtime environment of the secure element hardware platform identifies and saves static resources included in the old version of the executable load file pursuant to the instructions within the upgrade command. Additionally, or alternatively, the system may include instructions within the upgrade command indicating that certain static resources should not be saved during the upgrade process.

One or more embodiments identify static resources included in an old version of an executable load file that should be saved during an upgrade process for the executable load file based on requests from application instances derived from the old version of the executable load file that are running on the secure element hardware platform at the outset of the upgrade process. For instance, during the upgrade process, the system may offer these application instances a special application programming interface that is used for making these requests to save static resources. This special application interface may be included in a runtime environment of the secure element hardware platform. Upon receiving a request from an application instance to save a static resource, the runtime environment may complete the request, or the runtime environment may decline the request if this request conflicts with instructions included in an upgrade command for the upgrade process.

One or more embodiments generate an upgrade command that includes instructions for restoring static resources that are saved from an old version of the executable load file during an upgrade process for the executable load file to a new version of an executable load file. For instance, prior to initiating the upgrade process, the system may determine that certain static resources that will be saved from the old version of the executable load file should be restored to the new version of the executable load file. Based on this determination, the system may generate an upgrade command that includes instructions for restoring these static resources. These instructions may be encoded into a special parameter that is added to the upgrade command by the system for this purpose. After receiving the upgrade command, saving static resources, and deploying the new executable load file onto the secure element hardware platform, a runtime environment of the secure element hardware platform may restore saved static resources to the new version of the executable load file pursuant to the instructions within the upgrade command. Additionally, or alternatively, the system may include instructions within the upgrade command indicating that certain static resources should not be restored during the upgrade process.

One or more embodiments identify saved static resources included in an old version of an executable load file that should be restored to a new version of the executable load file during an upgrade process for the executable load file based on requests from application instances derived from the new version of the executable load file that are initialized on the secure element hardware platform in the course of the upgrade process. For instance, after these application instances are initialized during the upgrade process, the system may offer these application instances a special application programming interface that is used for making these requests to restore saved static resources. This special application interface may be included in a runtime environment of the secure element hardware platform. Upon receiving a request from an application instance to restore a static resource, the runtime environment may complete the request, or the runtime environment may decline the request if this request conflicts with instructions included in an upgrade command for the upgrade process.

One or more embodiments generate an upgrade command that includes instructions for skipping upgrade operations that are unrelated to updating static resources included in an executable load file that is deployed on a secure element hardware platform. For instance, if an upgrade process is not attempting to update resources of the executable load file other than static resources, the system may generate an upgrade command that directs a runtime environment of the secure element hardware platform to apply updates to the static resources while skipping upgrade operations that are typically used to update other parts of an executable load file such as executable instructions. In this way, the system may update the static resources of the executable load file that is deployed on the secure element hardware platform without disrupting application instances derived from the executable load file that are running on the secure element hardware platform at the outset of the upgrade process. Furthermore, by skipping these upgrade operations, the system may prevent the application instances from generating requests to save and/or restore static resources during the upgrade process in a manner that is counterproductive to the updates to the static resources that are being applied by the system.

One or more embodiments described in this Specification and/or recited in the claims may not be included in this General Overview section.

### 2. ARCHITECTURAL OVERVIEW

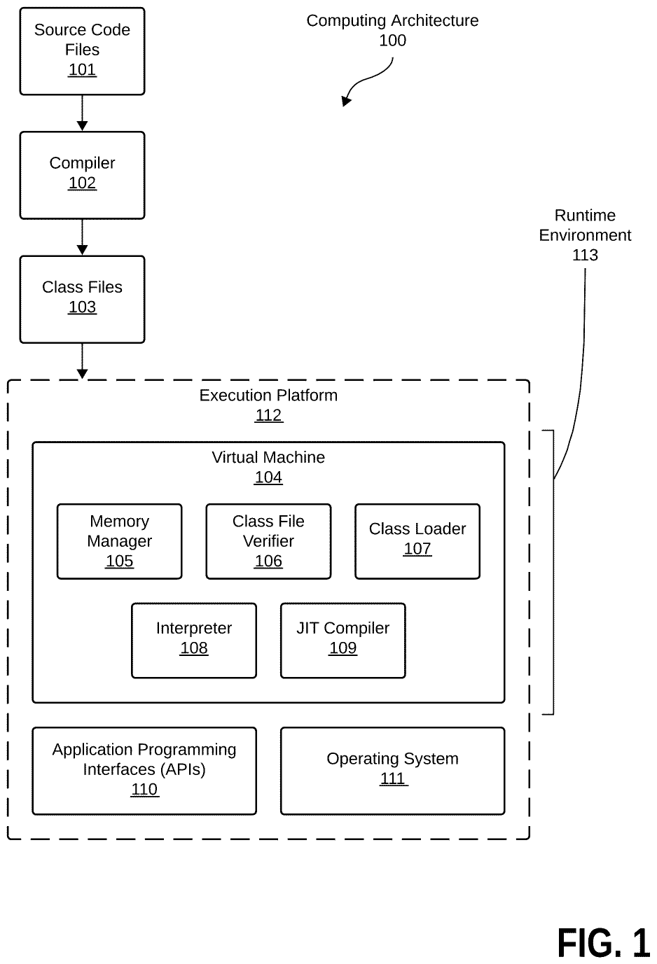

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the Java Virtual Machine (JVM), the Java Virtual Machine Specification defines a particular class file format to which the class files 103 are expected to adhere. In some embodiments, the class files 103 include the virtual machine instructions that have been converted from the source code files 101. However, in other embodiments, the class files 103 may include other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may include one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

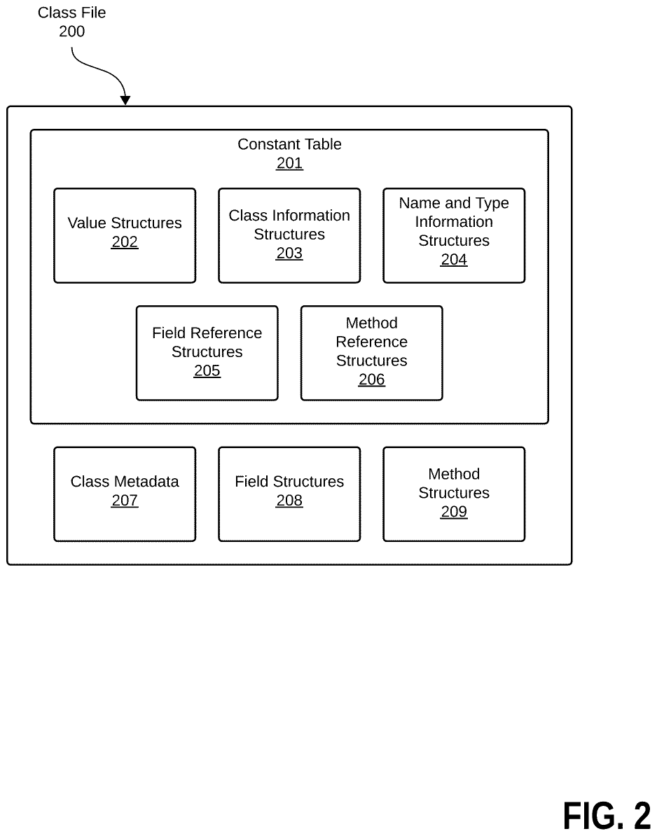

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13( ) {
      return B.addTwo(12, 13);
   }
}

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

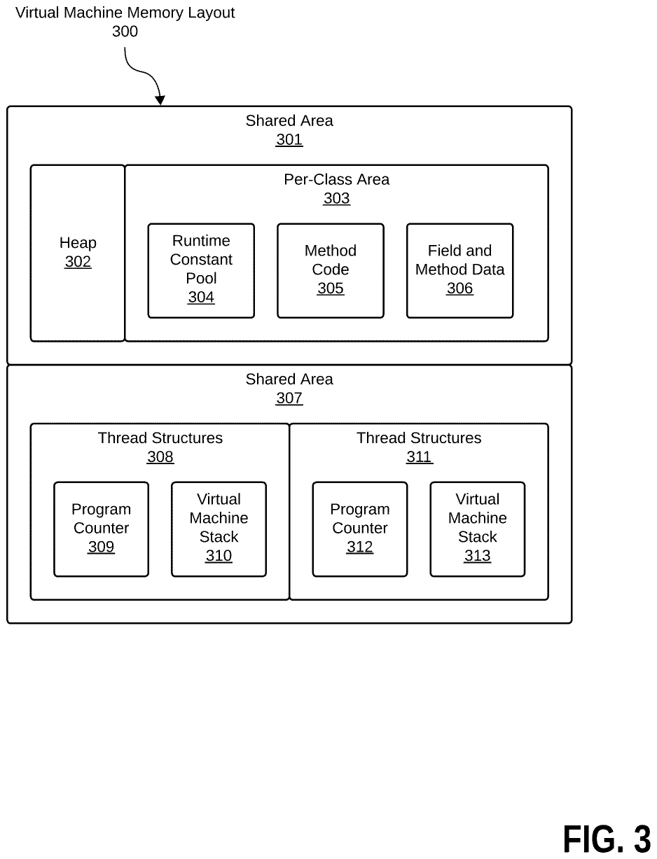

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

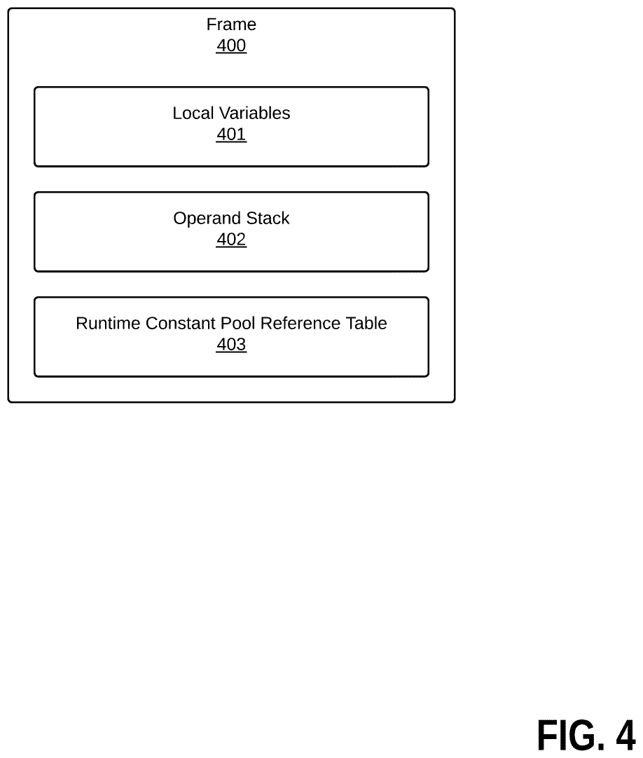

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 includes a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A includes a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. UPGRADE ARCHITECTURE

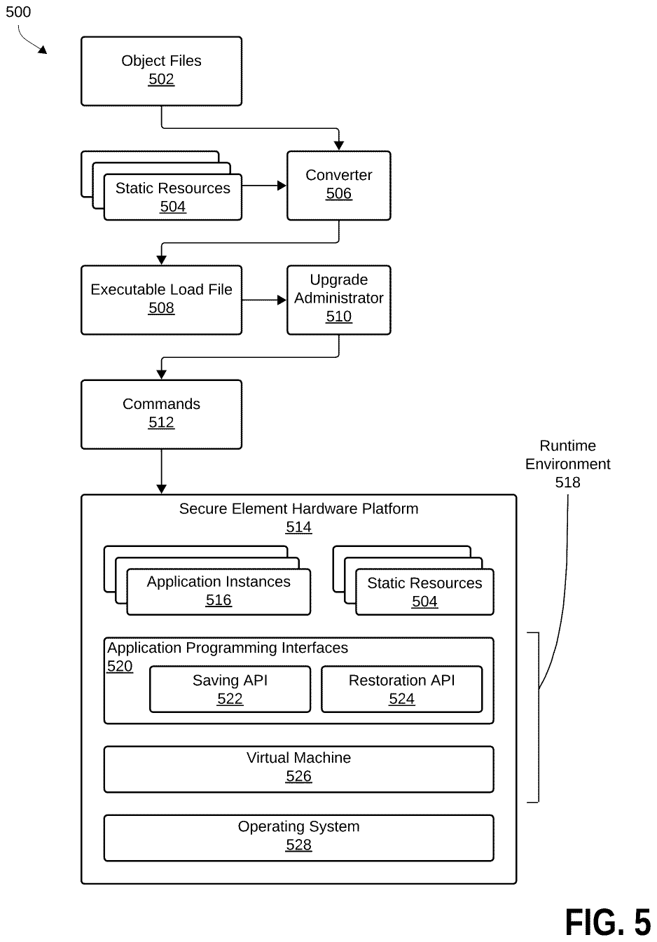

FIG. 5 illustrates an example architecture 500 for upgrading an executable load file in accordance with one or more embodiments. As illustrated in FIG. 5, architecture 500 may include object files 502, static resources 504, converter 506, executable load file 508, upgrade administrator 510, commands 512, and secure element hardware platform 514. In one or more embodiments, architecture 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

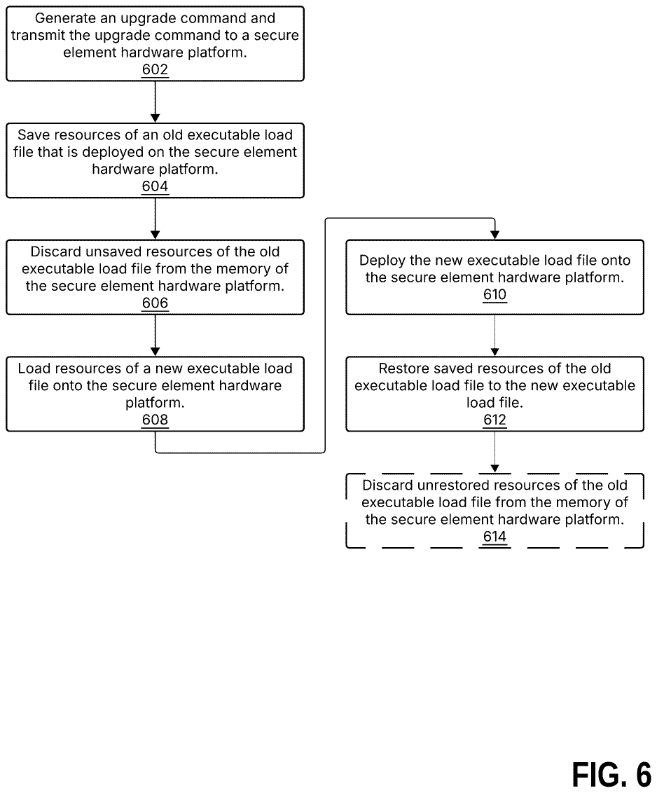

In one or more embodiments, architecture 500 refers to software and/or hardware configured for upgrading an executable load file 508. Example operations for upgrading an executable load file are described below with reference to FIG. 6.

In an embodiment, architecture 500 is implemented using one or more class-based, object-oriented programming languages; to provide a concise explanation, the remainder of this section shall assume the same. However, the implementation of architecture 500 in the context of a class-based, object-oriented program language is described herein for illustrative purposes and is not intended to define any limits to the disclosure. A class-based, object-oriented programming language is neither essential nor necessary to practice the techniques described herein. The techniques described herein are equally applicable to other programming languages. Examples of class-based, object-oriented programming languages include Java, C++, C#, Python, Ruby, and others. In an example, architecture 500 is implemented, at least in part, using the Java programming language. To provide consistent examples, the Java programming language is used as an example at multiple points in this Upgrade Architecture section.

In one or more embodiments, object files 502 refer to virtual machine instructions and associated metadata. The virtual machine instructions and associated metadata of objects files 502 are derived from source code that may declare packages, classes, interfaces, static methods, virtual methods, interface methods, static fields, instance fields, and other elements. With respect to the example that is described above in reference to FIG. 1, source code files 101 may be converted into object files 502 by compiler 102. The virtual machine instructions within object files 502 may be expressed as bytecode or another intermediate representation. The virtual machine instructions included in object files 502 correspond to methods defined in the source code. For example, an object file 502 for a reference type, such as a class, an interface, a record class, or an enum, may include bytecode for performing a method defined by the reference type. The bytecode for a method typically includes operation codes (referred to herein as “opcodes”) as well as other parameters. In an example, object files 502 are Java class files that are formatted in accordance with the JVM Specification.

In an embodiment, object files 502 are derived from source code that specifies an application and/or library that is configured for a resource-constrained environment such as secure element hardware platform 514. However, note that the format of object files 502 may not be well suited for some resource-constrained environments. For instance, the size of object files 502 may be impractical for a computing environment with limited memory resources. Furthermore, object files 502 may be designed for a larger computing architecture than a resource-constrained environment is configured to accommodate. As an example, assume that object files 502 include bytecode specified using opcodes from the JVM opcode vocabulary. The JVM opcode vocabulary is designed around a 32-bit word size for core operations. With respect to the architecture of a computing system, the term “word” may refer to the natural unit of data that the computing system is designed to manipulate while performing core operations. The word size of a computing system may be reflected in many aspects of the computing system's structure and operation, such as the size of registers, information pathways, memory addresses, instruction sets, and so on. As a result, it may be impractical to execute bytecode in an execution environment that is designed for a smaller word size than the bytecode is configured for. Thus, bytecode that is specified using JVM opcodes configured for a 32-bit word size may be poorly suited for computing architectures designed for a word size smaller than 32 bits, such as the 8-bit computing architectures and 16-bit computing architectures that are characteristic of some resource-constrained environments.

In one or more embodiments, a static resource 504 refers to a sequence of binary data that is included in an executable load file 508 along with executable instructions, such as application logic or libraries, that may rely on the static resource for some functionality during runtime. Static resources 504 are referred to as being “static” because static resources 504 are typically (a) defined before runtime and (b) not modified during runtime. In other words, static resources 504 are typically pre-defined, read-only data. Static resources 504 are also generally non-executable data. Example information that may be represented within an executable load file 508 as a static resource 504 includes lookup tables, cryptographic constants, configuration data, default parameters, security policies, precomputed values, data patterns, encoded templates, data formats, menus, user interface strings, fingerprints, hashes, and various other information that may be referenced by executable instructions during runtime.

In one or more embodiments, converter 506 refers to software and/or hardware configured to generate an executable load file 508 based on object files 502, static resources 504, and/or other information. Note that some executable load files 508 include static resources 504, whereas other executable load files 508 do not include static resources 504. In generating an executable load file 508, converter 506 may be configured to apply various transformations to object files 502 to reconfigure the virtual machine instructions and associated metadata of object files 502 for a resource-constrained environment such as secure element hardware platform 514. For example, converter 506 may replace symbolic references with tokens, translate virtual machine instructions into a different opcode vocabulary that is configured for a smaller word size, compress constant data, eliminate unused elements, simplify type hierarchies, resolve external dependencies, reorganize data into modular and size-efficient components, and/or apply various other transformations. In an example, object files 502 are Java class files, and converter 506 is configured to convert the Java class files and/or static resources 504 into a Converted Application (CAP) file that is formatted in accordance with the Java Card Platform Virtual Machine Specification.

In one or more embodiments, executable load file 508 refers to binary data that is configured for a resource-constrained environment such as secure element hardware platform 514. An example executable load file 508 includes virtual machine instructions derived from object files 502 and associated metadata that can be loaded onto secure element hardware platform 514. The example load file 508 may further include static resources 504 that may be relied upon by the virtual machine instructions to perform some functionality during runtime on secure element hardware platform 514. In an example, executable load file 508 is a CAP file that is formatted in accordance with the Java Card Platform Virtual Machine Specification. A CAP file is organized into various components, such as a header component, a directory component, an applet component, an import component, a constant pool component, a class component, a method component, a static field component, a reference location component, an export component, a descriptor component, a debug component, a static resource component, and/or a static resource component. Note that some components of a CAP file are optional components. For example, if a CAP file includes a static resource 504, that static resource 504 will be included in the static resource component of the CAP file. However, if a CAP does not include a static resource 504, the CAP file generally will not possess a static resource component.

In one or more embodiments, upgrade administrator 510 refers to software and/or hardware configured to administer an upgrade process for an executable load file 508. For example, upgrade administrator 510 may be configured to administer an upgrade process for upgrading an old version of an executable load file 508 that was previously deployed onto secure element hardware platform 514 into a new version of the executable load file 508 that is deployed onto the secure element hardware platform 514 during the upgrade process. An example upgrade process administered by upgrade administrator 510 includes a saving phase, a loading phase, and a restore phase. During an example saving phase of an upgrade process, values associated with an old version of an executable load file 508 are flagged for retention (i.e., “saved”) in memory of secure element hardware platform 514 for at least part of the upgrade process, and values associated with the old version of the executable load file 508 that are not saved are discarded. The values that are discarded during the example saving phase may include application instances 516 that were derived from the old version of the executable load file 508, static resources 504 of the old version of executable load file 508, and/or other information associated with the old version of the executable load file 508. During an example loading phase of an upgrade process, resources of a new version of an executable load file 508 are loaded onto secure element hardware platform 514. In general, the resources that are loaded onto secure element hardware platform 514 during the example loading phase may depend on what resources are being updated by the upgrade process and what resources from an old version of the executable load file 508 are saved during the upgrade process. During an example restore phase of an upgrade process, application instances 516 derived from a new version of an executable load file 508 are initialized on secure element hardware platform 514, and resources that were previously saved during the upgrade process are selectively restored to the new version of the executable load file 508, so these restored resources may subsequently be accessed by the application instances 516 that are derived from the new version of the executable load file 508.

In an embodiment, upgrade administrator 510 is configured to control an upgrade process for an executable load file 508 deployed on secure element hardware platform 514 by generating commands 512. For example, upgrade administrator 510 may generate a command 512 to initiate an upgrade process for upgrading an old version of an executable load file 508 into a new version of the executable load file 508, and upgrade administrator 510 may generate another command to load the new version of the executable load file 508 onto secure element hardware platform 514. In this example, upgrade administrator 510 may load the new version of the executable load file 508 onto secure element hardware platform 514 before initiating an upgrade process, or upgrade administrator 510 may upload the new version of the executable load file 508 onto secure element hardware platform 514 after initiating the upgrade process and during a loading phase of the upgrade process.

In an embodiment, upgrade administrator 510 is configured to interact with a user via an interface that is not illustrated in FIG. 5. The interface is software and/or hardware configured to facilitate communications between a user and components of architecture 500. Through the interface, a user may collaborate with upgrade administrator 510 to configure an upgrade process for an executable load file 508 that is deployed onto secure element hardware platform 514. For instance, the interface allows a user to specify resources that should or should not be retained in memory of secure element hardware platform 514 during a saving phase of an upgrade process for an executable load file 508. Furthermore, the interface allows a user to specify resources that should or should not be restored during a restore phase of an upgrade process for an executable load file 508 deployed on secure element hardware platform 514. The interface renders user interface elements and receives input via user interface elements. Example interfaces that may be included in architecture 500 include a graphical user interface (GUI), a command line interface (CLI), a haptic interface, and a voice command interface. Example user interface elements include checkboxes, radio buttons, dropdown lists, list boxes, buttons, toggles, text fields, date and time selectors, command lines, sliders, pages, and forms.

In one or more embodiments, a command 512 refers to a message that can be used to interact with a secure element hardware platform 514. In addition to other functions, a command 512 may be used to control an upgrade process for upgrading an executable load file 508 deployed on secure element hardware platform 514. In an example, a command 512 is an Application Protocol Data Unit (APDU) command that includes tag-length-variable (TLV) parameters. An example TLV parameter that may be encoded into an APDU command includes (a) a tag that specifies a type or purpose of the parameter, (b) a length that specifies a size of a value, and (c) the value.

In an embodiment, a command 512 is configured for controlling an upgrade process for upgrading an executable load file 508 that is deployed on secure element hardware platform 514. As used herein, the term “upgrade command” refers to a command 512 configured for controlling an upgrade process for an executable load file 508. An upgrade command 512 may include parameters for an upgrade process, and an upgrade command 512 may be used to initiate a new upgrade process, resume a current upgrade process, start a recovery procedure, abort a current upgrade process, request a status of an upgrade process, and/or perform other operations.

In an embodiment, an upgrade command 512 includes parameter(s) that specify resource(s) of an executable load file 508 that should be retained in memory of secure element hardware platform 514 for at least part of an upgrade process for the executable load file 508. Additionally, or alternatively, an upgrade command 512 includes parameter(s) that specify resource(s) of an executable load file 508 that should be discarded from memory of secure element hardware platform 514 during an upgrade process for the executable load file 508. In an example, an upgrade command 512 identifies resources of an executable load file 508 that should be saved during a saving phase of an upgrade process, and/or the upgrade command 512 identifies resources of the executable load file 508 that should be discarded during the saving phase of the upgrade process. An upgrade command 512 may specify if static resources 504 of an executable load file 508 should be saved or discarded, and/or an upgrade command 512 may specify if other types resources of the executable load file 508 should be saved or discarded.

In an embodiment, an upgrade command 512 includes instructions regarding the saving of certain static resource(s) 504 of an executable load file 508 in memory of secure element hardware platform 514 during an upgrade process for the executable load file 508. As an example, consider an upgrade process for upgrading an old version of an executable load file 508 deployed on secure element hardware platform 514 into a new version of the executable load file 508. In this example, an upgrade command 512 for the upgrade process may specify static resources 504 of the old executable load file 508 that should be saved in memory of the secure element hardware platform 514 during a saving phase of the upgrade process. The upgrade command 512 of this example is an APDU command, and the APDU command includes a special TLV parameter that is used for this purpose. In this example, the special TLV parameter may (a) identify specific static resources 504 that should be saved, (b) identify specific static resources 504 that should not be saved, (c) specify that the totality of the static resources 504 included in the old version of the executable load file 508 should be saved, and/or (d) specify that none of the static resources 504 included in the old version of the executable load file 508 should be saved.

In an embodiment, an upgrade command 512 includes parameter(s) that specify saved resource(s) of an executable load file that should be restored during an upgrade process for an executable load file 508. Additionally, or alternatively, an upgrade command 512 includes parameter(s) that specify resource(s) of an executable load file 508 that should not be restored during an upgrade process. As an example, consider a particular resource that was retained in memory of secure element hardware platform 514 during a saving phase of an upgrade process for an executable load file 508. In this example, an upgrade command 512 may specify whether or not that particular resource should be restored during a restore phase of the upgrade process. Note that a resource that is retained in memory of secure element hardware platform 514 during a saving phase of an upgrade process for an executable load file 508 will generally be discarded if that resource is not restored during a restore phase of the upgrade process. An upgrade command 512 may specify if static resources 504 of an executable load file 508 should be restored or discarded, and/or the upgrade command 512 may specify if other types of resources 508 of the executable load file 508 should be restored or discarded.

In an embodiment, an upgrade command 512 includes instructions regarding the restoration of static resource(s) 504 of an executable load file 508 during an upgrade process for the executable load file 508. As an example, consider an upgrade process for upgrading an old version of an executable load file 508 deployed on secure element hardware platform 514 into a new version of the executable load file 508. In this example, an upgrade command 512 for the upgrade process may specify if static resources 504 of the old version of the executable load file 508 that were saved during the saving phase of the upgrade process should be restored to new the new version of the executable load file 508 that is deployed during the upgrade process. The upgrade command 512 of this example is an APDU command, and the APDU command includes a special TLV parameter that is used for this purpose. In this example, the special TLV parameter may (a) identify specific static resources 504 that should be restored, (b) identify specific static resources 504 that should not be restored, (c) specify that the totality of the saved static resources 504 should be restored, and/or (d) specify that none of the saved static resources 504 should be restored.

In an embodiment, an upgrade command 512 instructs runtime environment 518 of secure element hardware platform 514 to perform a partial upgrade process for an executable load file 508 that is deployed onto the secure element hardware platform. In other words, an upgrade command 512 may direct runtime environment 518 to skip certain upgrade operations. In an example, an upgrade command 512 includes a particular parameter that indicates if resources of an executable load file 508 other than static resources 504 will be updated during an upgrade process. If the particular parameter indicates that resources other than static resources 504 will not be updated during the upgrade process in this example, a runtime environment 518 of the secure element hardware platform 514 is instructed to skip portions of the upgrade process that are unrelated to the static resources 504. For instance, in this example, the application instances 516 of the executable load file 508 that are already running on the secure element hardware platform 514 will not be destroyed during the saving phase of the upgrade process, and new application instances 516 will not be created during the restore phase of the upgrade process.

In an embodiment, a command 512 is configured for loading an executable load file 508 onto secure element hardware platform 514. As used herein, the term “load command” refers to a command 512 that is configured for loading an executable load file 508 onto secure element hardware platform 514. An example load command 512 is used to load resources of a new version of an executable load file 508 onto secure element hardware platform 508. The resources loaded onto secure element hardware platform 514 with a load command 512 may replace and/or supplement resources of an old version of an executable load file 508 that was previously deployed onto secure element hardware 514. Note that a load command 512 may include an entire executable load file 508, or a load command 512 may include part of an executable load file 508. In an example of the latter scenario, a load command 512 does not include a replacement resource for a resource that is (a) saved in memory of secure element hardware platform 514 during a saving phase of an upgrade process and (b) restored during a restore phase of the upgrade process.

In one or more embodiments, secure element hardware platform 514 refers to hardware and/or software configured for running application instances 516. Example secure element hardware platforms 514 include smart cards, embedded secure elements, universal integrated circuit cards (UICCs), subscriber identity module (SIM) cards, embedded subscriber identity modules (eSIM) cards, trusted platform modules (TPMs), integrated secure enclaves, and other devices. As illustrated in FIG. 5, secure element hardware platform 514 may include application instances 516, static resources 504, runtime environment 518, and operating system 528. In an example, secure element hardware platform 514 is a Java Card.

In one or more embodiments, an application instance 516 refers to an application and/or application dependencies configured for a resource-constrained environment such as secure element hardware platform 514. An application instance 516 is typically a runtime manifestation of executable instructions, such as virtual machine instructions and associated metadata, included in executable load file 508 that is deployed on secure element hardware platform 514. Furthermore, an application instance 516 often includes application data that is recorded and/or generated by the application instance 516 throughout the application instance's 516 lifecycle on secure element hardware platform 514. An example application instance 516 is configured to leverage the resources of secure element hardware platform 514 to perform a specific task. As an example, assume that secure element hardware platform 514 is a smart card. In this example, an application instance 516 may be configured to use an interface of the smart card to establish communications with a payment terminal and manage a secure transaction. Note that, in this example, the application instance 516 may be configured to rely on a static resource 504 in memory of secure element hardware platform 514 to perform some functionality. For instance, in this example, security policies that are used by the application instance 516 to establish communications and manage the secure transaction may be described by a static resource 504.

In one or more embodiments, runtime environment 518 refers to a layer of software infrastructure that facilitates the execution of application instances 516 on secure element hardware platform 514. To this end, runtime environment 518 may perform various functions, such as memory allocation, task scheduling, exception handling, garbage collection, security enforcement, and so on. Furthermore, runtime environment 518 is configured to facilitate an upgrade process for an executable load file 508 that is deployed onto secure element hardware platform 514. For example, runtime environment 518 is configured to perform upgrade operations pursuant to instructions that are included in upgrade commands 512. As illustrated in FIG. 5, runtime environment 518 includes application programming interfaces (APIs) 520 and virtual machine 526. In an example, runtime environment 518 is a Java Card Runtime Environment (JCRE) that is configured in accordance with a Java Card Platform Runtime Environment Specification.

In one or more embodiments, APIs 520 refer to a set of standardized virtual machine instructions and/or associated metadata that facilitate core functionalities of the runtime environment 518. For instance, APIs 520 may facilitate communications between virtual machine 526 and operating system 528. Furthermore, APIs 520 may include standardized instructions for responding to commands 512 and performing an upgrade process for upgrading an executable load file 508 deployed onto secure element hardware platform 514. As illustrated in FIG. 5, APIs 520 may include saving API 522 and restoration API 524. Additionally, or alternatively, APIs 520 include other APIs not illustrated in FIG. 5. In an example, APIs 520 includes the standard JCRE libraries as well as saving API 522 and restoration API 524.

In one or more embodiments, saving API 522 refers to method(s) for saving resources during an upgrade process for an executable load file 508 deployed on secure element hardware platform 514. As an example, consider an upgrade process for upgrading an old version of an executable load file 508 deployed on secure element hardware platform 514 into a new version of the executable load file 508. In this example, an application instance 516 derived from the old version of the executable load file 508 may invoke a method of saving API 522 to request that a resource of the old executable load file 508 is saved in memory of secure element hardware platform 514 during a saving phase of the upgrade process. A method of saving API 522 may be invoked to save static resources 504 of an executable load file 508 and/or other types of resources of the executable load file 508.

In an embodiment, saving API 522 includes method(s) for saving static resources 504 during an upgrade process for an executable load file 508 deployed on secure element hardware platform 514. For instance, saving API 522 may include a method that can be invoked by an application instance 516 to save a specific static resource 504 corresponding to an identifier that specified by the application instance 516 as a parameter of the request. Furthermore, the saving API 522 may include another method that can be invoked by an application instance 516 to save the totality of the static resources 504 that are accessible to that application instance 516. In an example, the methods of saving API 522 are defined by an upgrade manager class that is included in APIs 520.

In one or more embodiments, restoration API 524 refers to method(s) for restoring resources during an upgrade process for an executable load file 508 deployed on secure element hardware platform 514. As an example, consider an upgrade process for upgrading an old version of an executable load file 508 deployed on secure element hardware platform 514 into a new version of the executable load file 508. For the purposes of this example, assume that a particular resource from the old version of the executable load file 508 was saved in memory of secure element hardware platform 514 during a saving phase of the upgrade process pursuant to (a) a parameter in an upgrade command 512 and/or (b) a request by an application instance 516 derived from the old version of the executable load file 508. In this example, an application instance 516 that is derived from the new version of the executable load file 508 may request that the particular resource be restored to the new version of the executable load file 508 by invoking a method of restoration API 524. A method of restoration API 524 may be invoked to restore static resources 504 of an executable load file 508 and/or other types of resources of the executable load file 508.

In an embodiment, restoration API 524 includes method(s) for restoring static resource(s) 504 during an upgrade process for an executable load file 508 deployed on secure element hardware platform 514. For instance, restoration API 524 may include a method that can be invoked by an application instance 516 to restore a specific static resource 504 corresponding to an identifier that is specified by the application instance 516 as a parameter of the request. Furthermore, restoration API 524 may include another method that can be invoked by an application instance 516 to restore the totality of the static resources 504 that were saved during a saving phase of an upgrade process pursuant to (a) an upgrade command 512 of the upgrade process and/or (b) invocations of methods in the saving API 522. The restoration API 524 may also include another method that can be invoked by an application instance 516 to determine if a specific static resource 514 can be restored. In an example, the methods of restoration API 524 are defined by an upgrade manager class that is included in APIs 520.

In one or more embodiments, virtual machine 526 refers to an execution environment for virtual machine instructions. Virtual machine 526 may include one or more thread structures for this purpose. A thread structure of virtual machine 526 includes a program counter and a virtual machine stack. Virtual machine 526 can generate a new frame upon a method being invoked. An example frame generated by virtual machine 526 includes an operand stack, a local variables array, and a runtime constant pool reference table. Based on bytecode instructions included in a method of executable load file 508, virtual machine 526 may manipulate values on the operand stack, move values between the operand stack and local variables, and/or perform other operations. In an example, virtual machine 526 is a Java Card Virtual Machine (JCVM) that is configured in accordance with a Java Card Platform Virtual Machine Specification.

In one or more embodiments, operating system 528 refers to software and/or hardware configured to manage core functionalities of secure element hardware platform 514. For instance, operating system 528 may control access to hardware resources, manage memory allocation, enforce application-level security policies, and coordinate with virtual machine 526 to facilitate the execution of application instances 516. Furthermore, operating system 528 may be configured to receive and parse commands 512 and route the commands 512 to the appropriate recipient within the runtime environment 518 of secure element hardware platform 514.

In an embodiment, architecture 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. UPGRADING AN EXECUTABLE LOAD FILE

FIG. 6 illustrates an example set of operations for upgrading an executable load file in accordance with one or more embodiments. One or more operations illustrated in FIG. 6 may be modified, rearranged, or omitted. Accordingly, the sequence of operations illustrated in FIG. 6 should not be construed as limiting the scope of one or more embodiments.

In one or more embodiments, the system generates an upgrade command, and the system transmits the upgrade command to a secure element hardware platform (Operation 602). The system generates the upgrade command autonomously, or the system generates the upgrade command in collaboration with a user. By transmitting the upgrade command to the secure element hardware platform, the system initiates an upgrade process for upgrading the executable load file that is presently deployed on the secure element hardware platform. The upgrade command includes parameters for the upgrade process. The parameters within the upgrade command dictate that, during the upgrade process, resources of an executable load file that is presently deployed on the secure element hardware platform will be replaced and/or supplemented with resources of another executable load file that is loaded onto the secure element hardware platform. For example, during the upgrade process, resource of an old version of CAP file may be replaced and/or supplemented with resources of a new version of that CAP file. Hereafter, the executable load file that is presently deployed on the secure element hardware platform is referred to as “the old executable load file,” and the executable load file that will be deployed on the secure element hardware platform at the end of the upgrade process is referred to as “the new executable load file.” Note that resources in the old executable may be identical to resources in the new executable load file. Rather than deleting resources of the old executable load file that are not updated by the upgrade process, these resources may be retained in memory of the secure element hardware platform during the upgrade process and incorporated (i.e., restored) into the new executable load file. To this end, the parameters in the upgrade command may dictate (a) what resources of the old executable load file are retained in memory of the secure element hardware platform for at least part of the upgrade process, (b) what resources of the old executable load file are restored to the new executable load file during the upgrade process, and/or (c) what resources of the old executable load file are discarded from memory of the secure element hardware platform during the upgrade process. Within the upgrade command, the system may specify that static resources of the old executable load file should be retained, restored, and/or discarded, and/or the system may specify that other types of resources of the old executable load file should be retained, restored, and/or discarded. In an example, the upgrade command is an APDU command that includes special TLV parameter(s) that are used for this purpose.

In an embodiment, the system includes instructions in the upgrade command that specify static resources of the old executable load file that should be retained in memory of the secure element hardware platform for at least part of the upgrade process. For example, within the upgrade command, the system may include a particular parameter that is used to control the saving and/or discarding of static resources during a saving phase of the upgrade process. Within this particular parameter of the upgrade command, the system of this example may (a) identify static resources of the old executable load file that should be saved during the saving phase, (b) identify static resources of the old executable load file that should not be saved during the saving phase, (c) specify that the totality of the old executable load file's static resources should be saved during the saving phase, and/or (d) specify that none of the old executable load file's static resources should be saved during the saving phase. Note that if a resource of the old executable load file is not saved during the saving phase, that resource is generally discarded during the saving phase. It should also be noted that a resource of the old executable load file that is saved during the saving phase may or may not be restored to the new executable load file during a restore phase of the upgrade process.

In an embodiment, the system includes instructions in the upgrade command that specify static resources of the old executable load file that should be restored to the new executable load file during the upgrade process. For example, within the upgrade command, the system may include a particular parameter that is used to control the restoring and/or discarding of static resources during the restore phase of the upgrade process. Within this particular parameter of the upgrade command, the system of this example may (a) identify static resources of the old executable load file that should be restored during the restore phase, (b) identify static resources of the old executable load file that should not be restored during the restore phase, (c) specify that the totality of the static resources of the old executable load file that are saved in memory of the secure element hardware platform should be restored during the restore phase, and/or (d) specify that no static resources of the old executable load file that are saved in memory of the secure element hardware platform should be restored during the restore phase. Note that if a resource of the old executable load file is not restored to the new executable load file during the restore phase, that resource is generally discarded during the restore phase.

In an embodiment, the system includes instructions in the upgrade command that dictate how the runtime environment of the secure element hardware platform should handle requests from the application instances during the upgrade process. Note that during the upgrade process, application instance(s) derived from the old executable load file (hereafter “the old application instances”) may request that the runtime environment save certain resources of the old executable load file, and the application instance(s) that are derived from the new executable load file (hereafter “the new application instances”) may request that the runtime environment restore resources of the old executable load file to the new executable load file. These requests by the application instances may be directed to static resources or other types of resources. In some cases, these requests may be counterproductive. Accordingly, the system may include instructions in the upgrade command indicating if the runtime environment should block certain requests by the old application instances and/or the new application instances. As an example, assume that an old application instance attempts to save a particular static resource included in the old executable load file that possesses a particular identifier. If this particular static resource is saved pursuant to the old application instance's request and if an updated version of the particular static resource that possesses the same particular identifier is loaded onto the secure element hardware platform during the upgrade process, an error may occur, and/or the upgrade process may fail. In this example, the system may anticipate this request by the old application instance, and the system may include instructions in the upgrade command for blocking this request to prevent the adverse consequences that might other result from the request.

In an embodiment, the system includes instructions in the upgrade command that dictate how the runtime environment of the secure element hardware platform should handle requests from the old application instances during the upgrade process. Note that the logic of the old application instances that causes these requests may be outdated. In an example, the system includes, within the upgrade command, a particular parameter that is used to control how the runtime environment of the secure element hardware platform handles requests by the old application instances during the saving phase of the upgrade process. Within this particular parameter of the upgrade command, the system may specify that (a) none of the old application instances' requests to save resources of the old executable load file should be blocked, (b) a subset of the old application instances' requests to save resources of the old executable load file should be blocked, or (c) the totality of the old application instances' requests to save resources of the old executable load file should be blocked.

In an embodiment, the system includes instructions in the upgrade command that dictate how the runtime environment of the secure element hardware platform should handle requests from the new application instances during the upgrade process. Note that in some cases, the new application instances may be the old application instances. In an example, the system includes, within the upgrade command, a particular parameter that is used to control how the runtime environment of the secure element hardware platform handles request by the new application instances during the restore phase of the upgrade process. Within this particular parameter of the upgrade command, the system may specify that (a) none of the new application instances' requests to restore resources of the old executable load file should be blocked, (b) a subset of the new application instances' requests to restore resources of the old executable load file should be blocked, or (c) the totality of the new application instances' requests to restore resources of the old executable load file should be blocked.

In an embodiment, the system includes instructions in the upgrade command for skipping certain steps of the upgrade process. For example, within the upgrade command, the system may include a particular parameter that is used to indicate if resources of the old executable load file other than static resources will be updated during the upgrade process. If the system of this example specifies, within this particular parameter of the upgrade command, that no resources of the old executable load file other than static resources are updated during the upgrade process, the runtime environment of the secure element hardware platform is instructed to skip portions of the upgrade process that are unrelated to static resources. For instance, in addition to other operations of the upgrade process, the runtime environment of this example may abstain from discarding the old application instances during the upgrade process if upgrade command indicates that no resources other than the static resources are being updated.

In an embodiment, the system autonomously generates the upgrade command. The system may autonomously generate the upgrade command based on analyzing (a) the old executable load file, (b) source code, object files, and/or static resources that the old executable load file is derived from, (c) the new executable load file, (d) source code, object files, and/or static resources that the new executable load file is derived from, (e) characteristics of the secure element hardware platform, (f) user characteristics, and/or (g) other information. In an example, the system compares the old executable load file to the new executable load file. Based on this comparison, the system of this example determines if and what static resources from the old executable load file should be carried over to the new executable load file. If the system identifies a particular static resource of the old executable load file that should be carried over to the new executable load file in this example, the system may specify, within the upgrade command, that this particular static resource should be saved and/or restored during the upgrade process. For instance, if an identifier of a particular static resource in the old executable load file is referenced by application logic of the new executable load file, and if the particular static resource is absent from the resources of the new executable load file that will be loaded onto the secure element hardware platform during a loading phase of the upgrade process, the system of this example may conclude that this particular static resource should be saved and restored during the upgrade process. If the application logic of the old application instances and the new application instances does not provide for the saving and/or restoring of the particular static resource in this example, the system may include instructions within the upgrade command for saving and/or restoring this particular static resource.

In an embodiment, the system generates the upgrade command in collaboration with a user. The system may collaborate with a user by presenting communications to the user on an interface. To communicate with a user, the system may employ natural language processing, generative AI, such as a large language model, and/or various other mechanisms. In an example, the system generates communications to a user that solicit information that can be used to generate the upgrade command, and the system generates the upgrade command based on the user input that is received in response to the communications. In this example, the user input may specify static resources of the old executable load file that should be saved and/or restored during the upgrade process, and/or the user input may specify how requests from application instances should be handled during the upgrade process. In another example, the system autonomously identifies static resources of the old executable load file that may warrant saving and/or restoring during the upgrade process, and the system presents a suggested upgrade command to a user based on this analysis. For instance, in this example, the system may inspect application logic of the new application instances and the old application instances to determine if there is a disparity between (a) the static resources that will be saved by the old application instances and (b) the static resources that will be restored by the new application instances. If the new application instances include logic for restoring a particular static resource that is not saved by the old application instances, the system of this example may suggest an upgrade command that instructs the secure element hardware platform's runtime environment to save this particular static resource during the saving phase of the upgrade process. Additionally, or alternatively, the system of this example may inspect application logic of the old application instances to determine if the old application instances will attempt to save a static resource that is being updated by the upgrade process. If the old application instances will attempt to save a static resource that is being updated by the upgrade process in this example, the system may suggest an upgrade command that instructs the runtime environment to block this request by the old application instances.

In one or more embodiments, the system saves resource(s) of the old executable load file in memory of the secure element hardware platform (Operation 604). In particular, these resources of the old executable load file are saved in memory of the secure element hardware platform by the secure element platform's runtime environment during the saving phase of the upgrade process. The runtime environment may selectively save resources of the old executable load file pursuant to (a) instructions in the upgrade command, (b) requests from the old application instances, and/or (c) other stimuli. The runtime environment may save static resources of the old executable load file, and/or the runtime environment may save other types of resources of the old executable load file. Saving a resource residing at a location in memory of the secure element hardware platform may entail (a) preventing that location in memory from being deallocated and reclaimed by a garbage collector of the runtime environment and/or (b) creating a copy of that resource in another location in memory of the secure element hardware platform. If there are redundant directives to save a resource of the old executable load file, the runtime environment may ignore the redundant instructions. For example, if the upgrade command instructs the runtime environment to save a particular resource of the old executable load file and if an old application instance requests that the runtime environment save that same particular resource, the runtime environment may ignore one of these two directives. If there are conflicting directives, the runtime environment may identify and complete a priority directive and neglect other directives that conflict with the priority directive. For example, if the upgrade command instructs the runtime environment to discard a particular resource of the old executable load file during the saving phase of the upgrade process and if an old application instance requests that this particular resource be saved during the saving phase of the upgrade process, the runtime environment may block the old application instance's request. The directives that are prioritized by the runtime environment may vary depending on the circumstances. For example, how the runtime environment assigns priority to conflicting directives may be specified in an upgrade command.

In an embodiment, the system identifies and saves static resource(s) of the old executable load file based on instructions included in the upgrade command. For example, the upgrade command may include a particular parameter that is used to control the saving of static resources during the saving phase of the upgrade process, and the runtime environment of the secure element hardware platform may save a particular static resource of the old executable load file during the saving phase in response to the particular parameter, including an identifier of the particular static resource. In another example, the upgrade command includes a particular parameter that is used to control the saving of static resources during the saving phase of the upgrade process, and the runtime environment of the secure element hardware platform saves a particular static resource of the old executable load file based on the particular parameter specifying that the totality of the old executable load file's static resources should be saved during the saving phase of the upgrade process.

In an embodiment, the system identifies and saves static resource(s) of the old executable load file based on a request by an old application instance. As noted above, the secure element hardware platform's runtime environment includes a saving API that can be leveraged by the old application instances to save static resources of the old executable load file during the saving phase of the upgrade process. In an example, the runtime environment of the secure element hardware platform identifies and saves a particular static resource of the old executable load file based on an old application instance, invoking a method in the saving API for saving a specific static resource. In this example, the old application instance specifies an identifier of the particular static resource as a parameter of the request. In another example, an old application instance invokes a save all method of the saving API during the saving phase of the upgrade process. As a result, the secure element hardware platform's runtime environment saves the static resources of the old executable load file that are accessible to that old application instance in this example.

In one or more embodiments, the system discards unsaved resource(s) of the old executable load file from the memory of the secure element hardware platform (Operation 606). In particular, these resources are discarded by the runtime environment of the secure element hardware platform during the saving phase of the upgrade process. The unsaved resources of the old executable load file that are discarded by the runtime environment may include static resources and/or other types of resources. The specific resources of the old executable load file that are discarded by the runtime environment during the saving phase may depend on (a) instructions in the upgrade command, (b) requests by the old application instances, and (c) other stimuli. Note that the manner that a resource is discarded from memory of the secure element hardware platform may vary depending on (a) what type of memory the resource resides in, (b) the manner that garbage is collected in that type of memory, and/or (c) other factors. When a resource is discarded from memory of the secure element hardware platform, information describing that resource may still reside in memory space of the secure element hardware platform; however, that memory space may be deallocated and subsequently reclaimed for other information. In some cases, the discarded resources include at least some of the old application instances and the associated application data. In other cases, the old application instances are not discarded during the saving phase. In an example of the latter scenario, the application logic of the old executable load file is no different than the application logic of the new executable load file; therefore, there is no need to discard the old application instances during the upgrade process. In this example scenario, the old application instances become the new application instances.

In one or more embodiments, the system generates a load command that includes resources of the new executable load file, and the system transmits the load command to the secure element hardware platform (Operation 608). As a result, resources of the new executable load file are loaded onto the secure element hardware platform during a loading phase of the upgrade process. Alternatively, these resources of the new executable load file may be loaded onto the secure element hardware platform prior to initiating the upgrade process with the upgrade command. The resources of the new executable load file that are loaded onto the secure element hardware platform may include static resources and/or other types of resources. Generally, the resources that are loaded onto the secure element hardware platform with the load command are resources that are being updated or added by the upgrade process. Note that the resources that are loaded onto the secure element hardware platform during the upgrade process may correspond to one part of the new executable load file, and the resources of the old executable load file that are currently saved in memory of the secure element hardware platform may correspond to another part of the new executable load file that will be restored during the restore phase of the upgrade process. In an example, a load command is an APDU command that encodes one part of a CAP file that is being updated or added to the CAP file during the upgrade process, and the remainder of the CAP file that is not being updated by the upgrade process is already saved in the memory of the secure element hardware platform.

In one or more embodiments, the system deploys the new executable load file onto the secure element hardware platform (Operation 610). In particular, the new executable load file is deployed by the secure element hardware platform's runtime environment during the restore phase of the upgrade process. In deploying the new executable load file, the runtime environment may initialize the new application instances based on application logic of the new executable load file that was loaded onto the secure element hardware platform during the loading phase of the upgrade process. Alternatively, if the old application instances are the new application instances, there may be no need to initialize the new application instances, for the old application instances may have been retained in memory of the secure element hardware platform during the saving phase of the upgrade process.

In one or more embodiments, the system restores resource(s) of the old executable load file to the new executable load file (Operation 612). In particular, these resources of the old executable load file are restored to the new executable load file by the secure element hardware platform's runtime environment during the restore phase of the upgrade process. The runtime environment of the secure element hardware platform may selectively restore resources to the new executable load file pursuant to (a) instructions in the upgrade command, (b) requests by the new application instances, and/or (c) other stimuli. In general, restoring a resource to the new executable load file will allow at least a subset of the old application instances to subsequently access that resource during runtime. The resources that are restored by the runtime environment may include static resources and/or other types of resources. In an example, the runtime environment restores resources to the new executable load file by modifying an updated CAP file that was loaded onto the secure element hardware platform during the loading phase to include resources from an outdated CAP file that were saved in memory during the saving phase. In another example, the runtime environment restores resources to the new executable load file by modifying an outdated CAP file that was saved in memory during the saving phase to include updated resources that are loaded onto the secure element hardware platform during the loading phase.

In an embodiment, the runtime environment restores static resource(s) to the new executable load file. As an example, assume that the runtime environment saved a particular static resource of an outdated CAP file during the saving phase pursuant to instructions included in the upgrade command/or a request by an old application instance, and further assume that an updated CAP file is loaded onto the secure element hardware platform during the loading phase. In this example, the runtime environment is directed to restore the particular static resource to the updated CAP file during the restore phase pursuant to instructions in the upgrade command and/or a request by a new application instance. As noted above, a static resource component is an optional component of a CAP file that is present if the CAP file includes at least one static resource. If the updated CAP file already includes at least one static resource when loaded onto the secure element hardware platform in this example, then the updated CAP file already possesses a static resource component, and the runtime environment restores the particular static resources by modifying the preexisting static resource component of the updated CAP file to include the particular static resource. Alternatively, if the updated CAP file does not already include at least one static resource, the runtime environment restores the particular static resource by creating a new static resource component for the updated CAP file that includes the particular static resource.

In an embodiment, the system selectively restores static resource(s) of the old executable load file to the new executable load file based on instructions included in the upgrade command. In an example, the upgrade command includes a particular parameter that is used to indicate what static resources should be restored during the restore phase of the upgrade process. In this example, the runtime environment of the secure element hardware platform restores a particular static resource of the old executable load file to the new executable load file in response to the particular parameter (a) identifying the particular static resource or (b) specifying that the totality of the static resources that were saved during the saving phase of the upgrade process should be restored during the restore phase. In another example, the upgrade command includes a particular parameter that is used to identify static resources that should not be restored during the restore phase of the upgrade process. In this example, the runtime environment of the secure element hardware platform blocks a new application instance's request to restore a particular resource based on the particular parameter (a) identifying that particular resource, (b) identifying that new application instance, or (c) specifying that the totality of the requests from the new application instances to restore static resources should be blocked.

In an embodiment, the system selectively restores static resource(s) of the old executable load file based on a request by a new application instance. As noted above, the secure element hardware platform's runtime environment includes a restoration API that can be leveraged by the new application instances to restore resources of the old executable load file that were saved during the saving phase of the upgrade process pursuant to instructions in the upgrade command and/or requests by the old application instances. In an example, the runtime environment restores a particular static resource of the old executable load file to a new application instance in response to the new application instance invoking a method in the restoration API for restoring a specific static resource. In this example, the new application instance specifies an identifier of the particular static resource as a parameter of the request. In another example, a new application instance invokes a restore all method of the restoration API. In response, the runtime environment of this example restores the totality of the static resources of the old executable load file that were saved during the saving phase of the upgrade process pursuant to instructions in the upgrade command and/or invocations of the saving API by the old application instances.

In one or more embodiments, the system may discard unrestored resource(s) of the old executable load file from the memory of the secure element hardware platform (Operation 614). In particular, these unrestored resources of the old executable load file may be discarded by the secure element hardware platform's runtime environment during the restore phase of the upgrade process. However, if the totality of the resources of the old executable load file that were saved during the saving phase of the upgrade process were restored to the new executable load file, the runtime environment may skip this operation.

### 5. EXAMPLE EMBODIMENTS

Detailed examples are described below for purposes of clarity. Components and/or operations described below should be understood as specific examples that may not be applicable to certain embodiments. Accordingly, components and/or operations described below should not be construed as limiting the scope of any of the claims.

### 5.1 Upgrading Static Resources and Executable Instructions

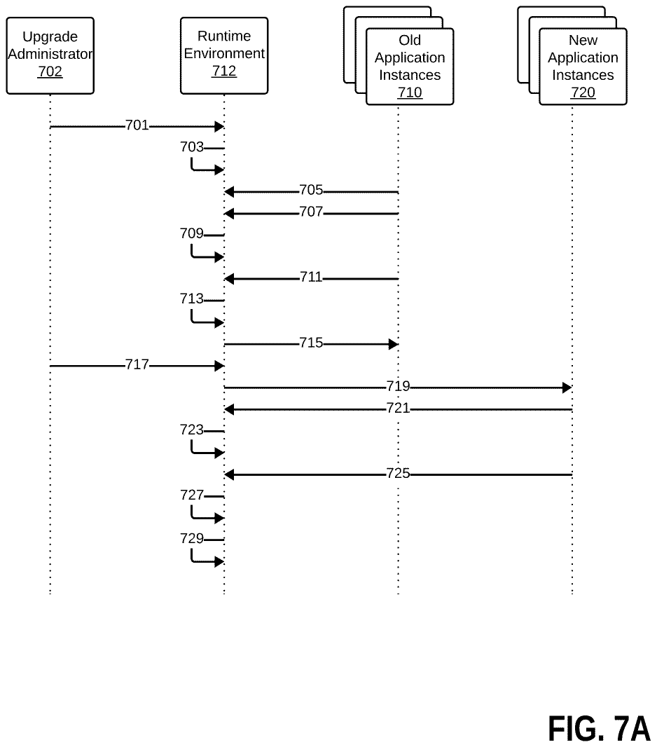

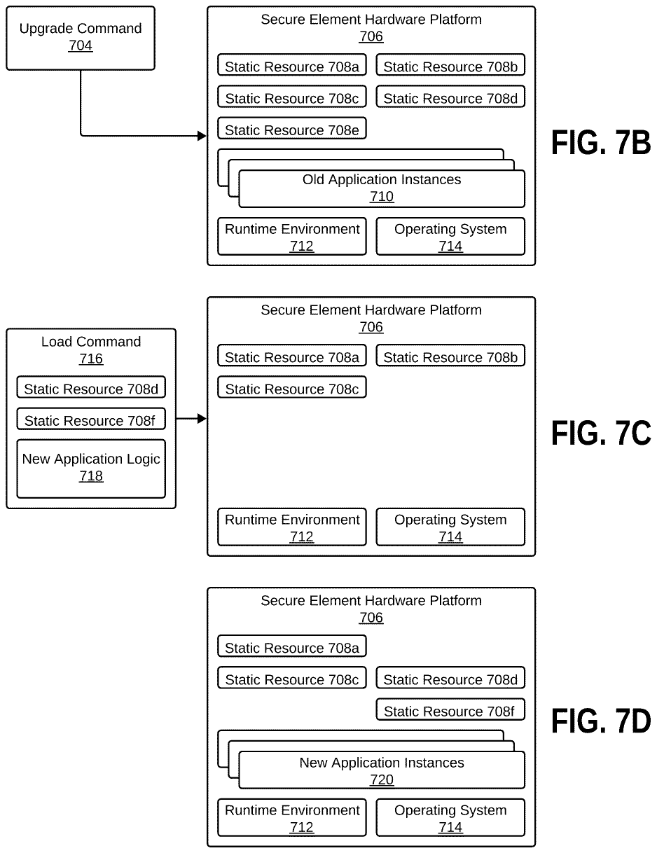

FIG. 7A illustrates operations of an example upgrade process for an executable load file that is deployed on a secure element hardware platform in accordance with an example embodiment. In particular, FIG. 7A illustrates an example set of operations for upgrading static resources and application logic of a CAP file that is deployed on the secure element hardware platform. This example upgrade process includes an example saving phase, an example loading phase, and an example restore phase. With respect to this example embodiment, FIG. 7B illustrates the secure element hardware platform at the beginning of the example saving phase, FIG. 7C illustrates the secure element hardware platform at the beginning of the example loading phase, and FIG. 7D illustrates the secure element hardware platform at the time the example restore phase is concluded. Hereafter, the version of the CAP file that is deployed on the secure element hardware platform at the start of this example upgrade process is referred to as “the outdated CAP file,” and the version of the CAP file that is deployed on the secure element hardware platform at the end of this example upgrade process is referred to as “the updated CAP file.”

In an example embodiment, an upgrade administrator 702 initiates the example saving phase of this example upgrade process by generating an upgrade command 704 and transmitting the upgrade command 704 to a secure element hardware platform 706 (Operation 701). As noted above, FIG. 7B illustrates the secure element hardware platform 706 at the beginning of the example saving phase of this example upgrade process. As illustrated in FIG. 7B, old application instances 710 that are derived from the outdated CAP file are running on the secure element hardware platform 706 at the outset of the example saving phase, and there are multiple static resources 708 from the outdated CAP file that are stored in the memory of the secure element hardware platform 706 at this time. In particular, the secure element hardware platform 706 stores static resource 708a, static resource 708b, static resource 708c, static resource 708d, and static resource 708e. The operating system 714 of the secure element hardware platform 706 receives the upgrade command 704 via a connection between the upgrade administrator 702 and the secure element hardware platform 706, and the operating system 714 forwards the upgrade command 704 to the runtime environment 712 of the secure element hardware platform 706. The upgrade command 704 instructs the runtime environment 712 to save a subset of the static resources 708 stored in memory of the secure element hardware platform 706 during the example saving phase. In particular, the upgrade command 704 instructs the runtime environment 712 to save static resource 708a and static resource 708c. This example upgrade process will update static resource 708d. Accordingly, the upgrade command 704 instructs the runtime environment 712 to prevent static resource 708d from being saved during the example saving phase.

In an example embodiment, the runtime environment 712 of the secure element hardware platform 706 saves static resource 708a and static resource 708c pursuant to instructions included in the upgrade command 704 by the upgrade administrator 702 (Operation 703). As a result, static resource 708a and static resource 708c will be retained in memory of the secure element hardware platform 706 until at least the example restore phase of this example upgrade process. After saving static resource 708a and static resource 708c, the runtime environment 712 triggers a data saving sequence for the old application instances 710. During the data saving sequence, the old applications instances 710 are permitted to request that certain resources, such as the static resources 708 and/or other resources, are saved in memory of the secure element hardware platform 706 during the example saving phase.

In an example embodiment, an old application instance 710 invokes a method for saving a specific static resource 708 in memory of the secure element hardware platform 706 during the example saving phase (Operation 705). The method for saving a specific static resource 708 is included in a saving API of the runtime environment 712. The old application instance 710 specifies an identifier of static resource 708a as a parameter of the request. As such, the old application instance 710 is requesting that the runtime environment 712 save static resource 708a during the example saving phase. However, as noted above, static resource 708a has already been saved by the runtime environment 712 pursuant to the instructions in the upgrade command 704. Accordingly, the runtime environment 712 ignores this request by the old application instance 710.

In an example embodiment, an old application instance 710 invokes the method for saving a specific static resource 708 in memory of the secure element hardware platform 706 during the example saving phase (Operation 707). As noted above, the method for saving a specific static resource 708 is included in the saving API of the runtime environment 712. The old application instance 710 specifies an identifier of static resource 708b as a parameter of the request. As such, the old application instance 710 is requesting that the runtime environment 712 save static resource 708b during the example saving phase. Static resource 708b has not been saved during the example saving phase thus far, and the upgrade command 704 does not include an instruction that prevents the old application instance's 710 request. Accordingly, the runtime environment 712 will respond to this request by the old application instance 710.

In an example embodiment, the runtime environment 712 saves static resource 708b in memory of the secure element hardware platform 706 pursuant to the request by the old application instance 710 (Operation 709). As a result, static resource 708b will be retained in memory of the secure element hardware platform 706 until at least the example restore phase of this example upgrade process.

In an example embodiment, an old application instance 710 invokes the method for saving a specific static resource 708 in memory of the secure element hardware platform during the example saving phase 708 (Operation 711). As noted above, the method for saving a specific static resource 708 is included in the saving API of the runtime environment 712. The old application instance 710 specifies an identifier of static resource 708d as a parameter of the request. As such, the old application instance 710 is requesting that the runtime environment 712 save static resource 708d during the example saving phase. However, as noted above, the upgrade command 704 instructs the runtime environment 712 to prevent static resource 708d from being saved during the upgrade process. Accordingly, the runtime environment 712 denies this request by the old application instance 710.

In an example embodiment, the runtime environment 712 discards static resource 708d and static resource 708e from the memory of the secure element hardware platform 706 (Operation 713). Static resource 708d is discarded by the runtime environment 712 during the example saving phase because the upgrade command 704 prevented static resource 708d from being saved. Static resource 708e is discarded by the runtime environment 712 during the example saving phase because neither the upgrade command 704 nor the old application instances 710 directed the runtime environment 712 to save static resources 708e.

In an example embodiment, the runtime environment 712 discards the old application instances 710 from the memory of the secure element hardware platform 706 (Operation 715). The runtime environment 712 discards the old application instances 710 because the application logic of the outdated CAP file is being updated by this example upgrade process. After the runtime environment 712 discards the old application instances 710, the example saving phase is concluded and the example loading phase begins.

In an example embodiment, the upgrade administrator 702 initiates the example loading phase by generating a load command 716 and transmitting the load command 716 to the secure element hardware platform 706 (Operation 717). The load command 716 includes the updated CAP file. As noted above, FIG. 7C illustrates the secure element hardware platform 706 at the beginning of the example loading phase of this example upgrade process. As illustrated in FIG. 7C, the updated CAP file that is embedded within the load command 716 includes static resource 708d, static resource 708f, and new application logic 718. Note that the updated CAP file that is embedded within the load command 716 will subsequently be modified during the example restore phase of this example upgrade process. The version of static resource 708d that is included in the updated CAP file is an updated version of the static resource 708d that was included in the outdated CAP file and deleted from the memory of the secure element hardware platform 706 during the example saving phase. Static resource 708f is a new static resource 708 that is being added to the CAP file by this example upgrade process. The operating system 714 of the secure element hardware platform 706 receives the load command 716 via the connection between the upgrade administrator 702 and the secure element hardware platform 706, and the operating system 714 forwards the load command 716 to the runtime environment 712. After the load command 716 has been loaded onto the secure element hardware platform 706 in this manner, the example loading phase is concluded and the example restore phase begins.

In an example embodiment, the runtime environment 712 initiates the example restore phase by creating the new application instances 720 based on the new application logic 718 within the updated CAP file that was loaded onto the secure element hardware platform 706 during the example loading phase (Operation 719). The runtime environment 712 creates the new application instances 720 during an installation sequence of the example restore phase for the updated CAP file that was included in the load command 716. Static resource 708d and static resource 708f were included in a static resource component of the updated CAP file. Therefore, the new application instances 720 will subsequently be able to access static resource 708d and static resource 708f during program execution. However, at this time, the new application instances 720 are not yet able to access the static resources 708 or other resources that were saved in memory of the secure element hardware platform 706 during the example saving phase. Accordingly, after creating the new application instances 720, the runtime environment 712 triggers a restore sequence that will allow the new application instances 720 to request restoration of resources that were saved in memory of the secure element hardware platform 706 during the example saving phase.

In an example embodiment, a new application instance 720 invokes a method for restoring a specific static resource 708 that was saved in memory of the secure element hardware platform 706 during the example saving phase (Operation 721). The method for restoring a specific static resource 708 is included in a restoration API of the runtime environment 712. The new application instance 720 specifies an identifier of the static resource 708a as a parameter of the request. As such, the old application instance 720 is requesting that the runtime environment 712 restore static resource 708a to the new application instance 720 during the example restore phase. The upgrade command 704 does not include an instruction that prevents the new application instance's 720 request. Accordingly, the runtime environment 712 will respond to this request by the new application instance 720.

In an example embodiment, the runtime environment 712 modifies the updated CAP file that was loaded onto the secure element hardware platform 706 during the example loading phase in response to the new application instance's 720 request (Operation 723). In particular, the runtime environment 712 modifies the static resource component of the updated CAP file to include static resource 708a. As a result, the new application instance 720 will subsequently be able to access static resource 708a during program execution. Note that the updated CAP file included a static resource component when the updated CAP file was loaded onto the secure element hardware platform 706 during the example loading phase because the updated CAP file included static resource 708d and static resource 708f at that time. Thus, the runtime environment 712 is modifying the existing static resource component of the updated CAP file rather than creating a new static resource component for the updated CAP file.

In an example embodiment, a new application instance 720 invokes the method for restoring a specific static resource 708 that was saved in memory of the secure element hardware platform 706 during the example saving phase (Operation 725). As noted above, the method for restoring a specific static resource 708 is included in a restoration API of the runtime environment 712. The new application instance 720 specifies an identifier of the static resource 708c as a parameter of the request. As such, the new application instance 720 is requesting that the runtime environment 712 restore static resource 708c to the new application instance 720 during this example restore phase. The upgrade command 704 does not include an instruction that prevents the new application instance's 720 request. Accordingly, the runtime environment 712 will respond to this request by the new application instance 720.

In an example embodiment, the runtime environment 712 modifies the updated CAP file that was loaded onto the secure element hardware platform 706 during the example loading phase in response to the new application instance's 720 request (Operation 727). In particular, the runtime environment 712 modifies the static resource component of the updated CAP file to include static resource 708c. As a result, the new application instance 720 will subsequently be able to access static resource 708c during program execution.

In an example embodiment, the runtime environment 712 discards static resource 708b from the memory of the secure element hardware platform 706 (Operation 729). The runtime environment 712 discards static resource 708b during the example restore phase because neither the upgrade command 704 nor the new application instances 720 have directed the runtime environment 712 to restore static resource 708b. After the runtime environment 712 discards static resource 708b, the example restore phase is concluded. As noted above, FIG. 7D illustrates the secure element hardware platform 706 at the time the example restore phase of this example upgrade process is concluded. The conclusion of the example restore phase marks the completion of this example upgrade process.

### 5.2 Upgrading Static Resources

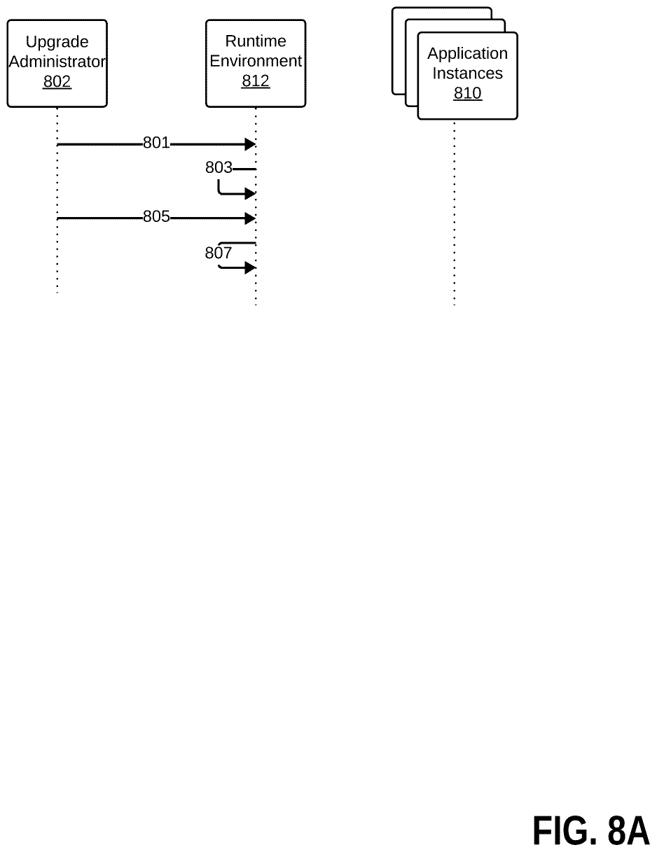

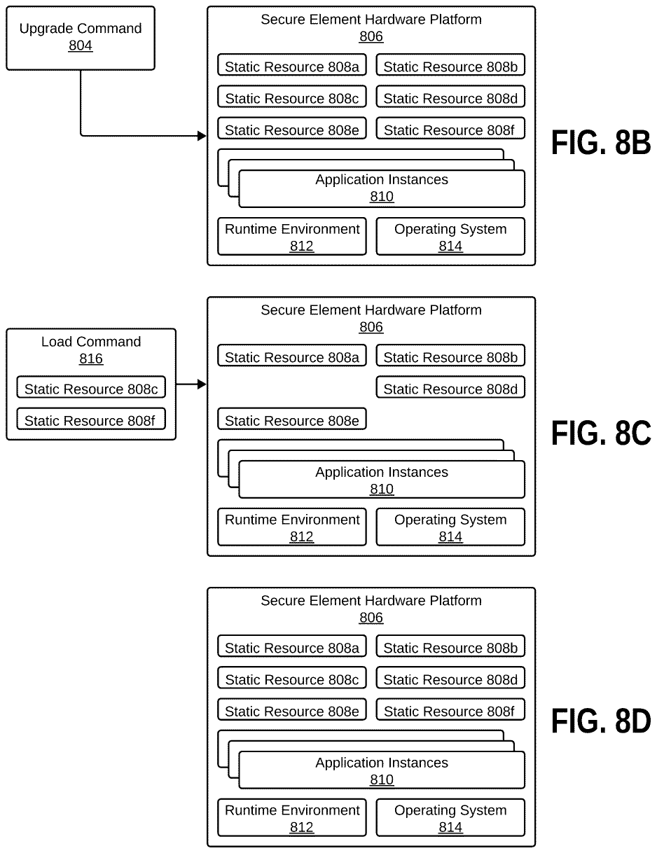

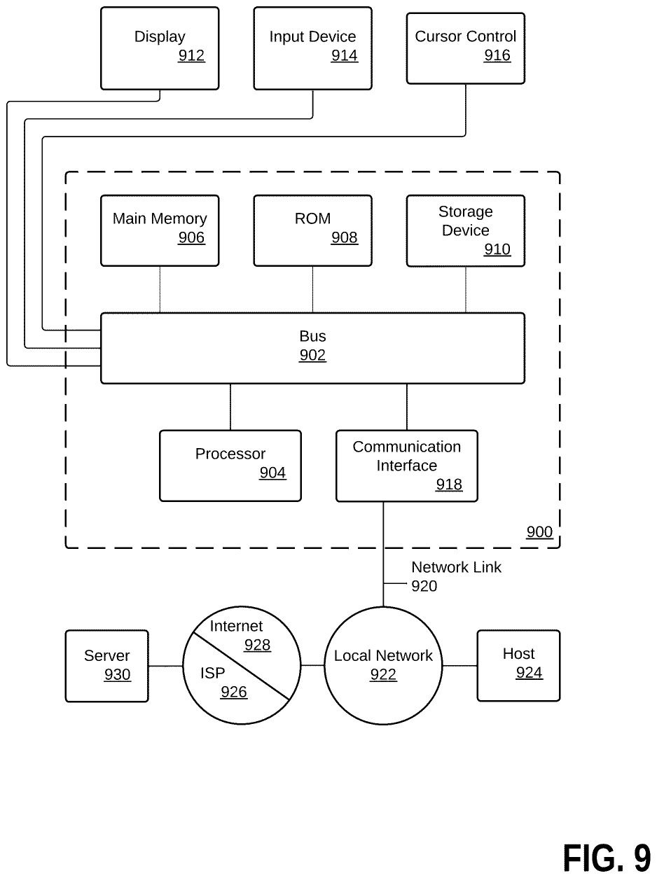

FIG. 8A illustrates operations of an example upgrade process for an executable load file that is deployed on a secure element hardware platform in accordance with an example embodiment. In particular, FIG. 8A illustrates an example set of operations for upgrading the static resources of a CAP file that is deployed on the secure element hardware platform in accordance with an example embodiment. The application logic of the CAP file is not updated in this example. This example upgrade process includes an example saving phase, an example loading phase, and an example restore phase. With respect to this example embodiment, FIG. 8B illustrates the secure element hardware platform 806 at the beginning of the example saving phase, FIG. 8C illustrates the secure element hardware platform 806 at the beginning of the example loading phase, and FIG. 8D illustrates the secure element hardware platform 806 at the time the example restore phase is concluded. Hereafter, the version of the CAP file that is deployed on the secure element hardware platform at the start of this example upgrade process is referred to as “the outdated CAP file,” and the version of the CAP file that is deployed on the secure element hardware platform at the end of this example upgrade process is referred to as “the updated CAP file.”

In an example embodiment, an upgrade administrator 802 initiates the example saving phase of this example upgrade process by generating an upgrade command 804 and transmitting the upgrade command 804 to the secure element hardware platform 806 (Operation 801). As noted above, FIG. 8B illustrates the secure element hardware platform 806 at the beginning of the example saving phase of this example upgrade process. As illustrated in FIG. 8B, application instances 810 that are derived from the outdated CAP file are running on the secure element hardware platform 806 at the outset of the example saving phase, and there are multiple static resources 808 from the outdated CAP file that are stored in the memory of the secure element hardware platform 806 at this time. In particular, the secure element hardware platform 806 stores static resource 808a, static resource 808b, static resource 808c, static resource 808d, static resource 808e, and static resource 808f. The operating system 814 of the secure element hardware platform 806 receives the upgrade command 804 via a connection between the upgrade administrator 802 and the secure element hardware platform 806, and the operating system 814 forwards the upgrade command 804 to the runtime environment 812 of the secure element hardware platform 806. The upgrade command 804 instructs the runtime environment 812 to discard a subset of the static resources 808 that are being updated by this example upgrade process. In particular, the upgrade command 804 instructs the runtime environment 812 to discard static resource 808c and static resource 808f. The upgrade command 804 also instructs the runtime environment 812 to refrain from performing certain upgrade operations that would otherwise be included in this example upgrade process. In particular, the upgrade command 804 instructs the runtime environment 812 to skip at least some upgrade operations that are unrelated to updating the static resources 808.

In an example embodiment, the runtime environment 812 discards static resource 808c and static resource 808f pursuant to the instructions included in the upgrade command 804 (Operation 803). The other static resources 808 are retained in memory of the secure element hardware platform 806 during the example saving phase. Note that during the example saving phase, runtime environment 812 does not trigger a data saving sequence for the application instances 810. Instead, the runtime environment 812 skips this step of this example upgrade process pursuant to the instructions in the upgrade command 804. As a result, the application instances 810 are prevented from attempting to save static resource 806c or static resource 808f. It should also be noted that the runtime environment 812 does not discard the application instances 810. Instead, the runtime environment 812 skips this step of the upgrade process pursuant to the instructions in the upgrade command 812. As a result, the example saving phase is concluded, and the example loading phase begins after static resource 808c and static resource 808f are discarded.

In an example embodiment, the upgrade administrator 802 initiates the example loading phase by generating a load command 816 and transmitting the load command 816 to the secure element hardware platform 806 (Operation 805). As noted above, FIG. 8C illustrates the secure element hardware platform 806 at the beginning of the example loading phase of this example upgrade process. As illustrated in FIG. 8C, the load command 816 includes static resource 808c and static resource 808f. The version of static resource 808c and static resource 808f that are included in the load command 816 are updated from the versions of these static resources 808 that were discarded from the memory of the secure element hardware platform 806 during the example saving phase. The operating system 814 of the secure element hardware platform 806 receives the load command 816 via the connection between the upgrade administrator 802 and the secure element hardware platform 806, and the operating system 814 forwards the load command 816 to the runtime environment 812. After the load command 816 has been loaded onto the secure element hardware platform 806 in this manner, the example loading phase is concluded and the example restore phase begins.

In an example embodiment, the runtime environment 812 modifies the outdated CAP file that is presently deployed on the secure element hardware platform 806 to create the updated CAP file (Operation 807). In particular, the runtime environment 812 modifies the static resource component of the outdated CAP file to include the versions of static resource 808c and static resource 808f that were loaded onto the secure element hardware platform 806 during the example loading phase with the load command 816. After the runtime environment 812 has modified the static resource component of the outdated CAP file in this manner, the application instances 810 will be able to access the updated versions of static resource 808c and static resource 808f. Note that during the example restore phase, the runtime environment 812 neither creates new application instances during an installation sequence of the example restore phase nor permits the application instances 810 to request restoration of static resources 808 during a restore sequence of the example restore phase. Instead, the runtime environment 812 skips these steps of this example upgrade process pursuant to the instructions in the upgrade command 812. After the runtime environment has created the updated CAP file by modifying the outdated CAP file, the example restore phase is concluded. As noted above, FIG. 8D illustrates the secure element hardware platform 806 at the time the example restore phase of this example upgrade process is concluded. The conclusion of the example restore phase marks the completion of this example upgrade process.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions included in main memory 806. Such instructions may be read into main memory 806 from another storage medium, such as storage device 810. Execution of the sequences of instructions included in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
initiating an upgrade process for upgrading an executable load file stored in memory of a secure element hardware platform from a first version of the executable load file into a second version the executable load file;
identifying a first static resource of the first version of the executable load file that is to be retained in the memory of the secure element hardware platform for at least part of the upgrade process based on at least one of (a) an upgrade command comprising instructions to retain the first static resource in the memory of the secure element hardware platform for at least part of the upgrade process or (b) a first request, by a first application instance, to retain the first static resource in the memory of the secure element hardware platform for at least part of the upgrade process, the first application instance corresponding to the first version of the executable load file;
discarding, from the memory of the secure element hardware platform, a first set of one or more resources corresponding to the first version of the executable load file, wherein the first set of one or more resources does not comprise the first static resource;
storing, in the memory of the secure element hardware platform, a second set of one or more resources corresponding to the second version of the executable load file; and
providing a second application instance access to the first static resource that is comprised within the memory of the secure element hardware platform, the second application instance corresponding to the second version of the executable load file.

2. The one or more non-transitory computer-readable media of claim 1:
wherein initiating the upgrade process is responsive to the secure element hardware platform receiving the upgrade command; and
wherein providing the second application instance access to the first static resource is based on at least one of (a) the upgrade command comprising instructions to provide the second application instance access to the first static resource or (b) a request, by the second application instance, for access to the first static resource.

3. The one or more non-transitory computer-readable media of claim 1, wherein the operations further comprise:
prior to providing the second application instance access to the first static resource:
based, at least in part, on the second set of one or more resources corresponding to the second version of the executable load file, initializing the second application instance on the secure element hardware platform; and
receiving, from the second application instance, a second request for access to the first static resource, wherein providing the second application instance access to the first static resource is responsive to receiving the second request.

4. The one or more non-transitory computer-readable media of claim 3:
wherein discarding the first set of one or more resources corresponding to the first version of the executable load file comprises:
discarding a second static resource of the first version of the executable load file from the memory of the secure element hardware platform based on at least one of (a) the upgrade command not comprising instructions to retain the second static resource in the memory of the secure element hardware platform for at least part of the upgrade process or (b) one or more application instances corresponding to the first version of the executable load file not requesting that the second static resource be retained in the memory of the secure element hardware platform for at least part of the upgrade process; and
discarding the first application instance from the memory of the secure element hardware platform; and
wherein storing the second set of one or more resources corresponding to the second version of the executable load file comprises:
storing, in the memory of the secure element hardware platform, a third static resource of the second version of the executable load file to replace the second static resource of the first version of the executable load file.

5. The one or more non-transitory computer-readable media of claim 1:
wherein identifying the first static resource is based on the upgrade command comprising the instructions to retain the first static resource in the memory of the secure element hardware platform;
wherein the first set of one or more resources comprises a second static resource of the first version of the executable load file;
wherein the second set of one or more resources comprises a third static resource of the second version of the executable load file to replace the second static resource of the first version of the executable load file; and
wherein providing the second application instance access to the first static resource is based on the upgrade command comprising instructions for providing the second application instance access to the first static resource.

6. The one or more non-transitory computer-readable media of claim 5:
wherein the upgrade command comprises instructions for skipping one or more steps of the upgrade process;
wherein the first application instance is prevented from creating the first request based on the upgrade command comprising the instructions for skipping the one or more steps of the upgrade process;
wherein the first set of one or more resources does not comprise the first application instance; and
wherein the first application instance is the second application instance.

7. The one or more non-transitory computer-readable media of claim 1, wherein the operations further comprise:
based on the upgrade command comprising instructions for preventing one or more static resources corresponding to the first version of the executable load file from being retained in the memory of the secure element hardware platform, performing at least one of:
(a) prior to discarding the first set of one or more resources corresponding to the first version of the executable load file, declining a second request, by the first application instance, to retain a second static resource of the first version of the executable load file in the memory of the secure element hardware platform for at least part of the upgrade process, wherein the first set of one or more resources comprises the second static resource; or
(b) subsequent to discarding the first set of one or more resources corresponding to the first version of the executable load file, declining a third request, by the second application instance, for access to a third static resource of the first version of the executable load file that is comprised within the memory of the secure element hardware platform.

8. The one or more non-transitory computer-readable media of claim 1:
wherein the first version of the executable load file is a first version of a converted applet (CAP) file;
wherein the second version of the executable load file is a second version of the CAP file; and
wherein providing the second application instance access to the first static resource comprises one of:
(a) if the second set of one or more resources does not comprise at least one static resource, creating, by the secure element hardware platform, a static resource component for the second version of the CAP file, the static resource component comprising the first static resource; or
(b) if the second set of one or more resources comprises at least one static resource, modifying, by the secure element hardware platform, the static resource component of the second version of the CAP file to comprise the first static resource.

9. A method comprising:
initiating an upgrade process for upgrading an executable load file stored in memory of a secure element hardware platform from a first version of the executable load file into a second version the executable load file;
identifying a first static resource of the first version of the executable load file that is to be retained in the memory of the secure element hardware platform for at least part of the upgrade process based on at least one of (a) an upgrade command comprising instructions to retain the first static resource in the memory of the secure element hardware platform for at least part of the upgrade process or (b) a first request, by a first application instance, to retain the first static resource in the memory of the secure element hardware platform for at least part of the upgrade process, the first application instance corresponding to the first version of the executable load file;
discarding, from the memory of the secure element hardware platform, a first set of one or more resources corresponding to the first version of the executable load file, wherein the first set of one or more resources does not comprise the first static resource;
storing, in the memory of the secure element hardware platform, a second set of one or more resources corresponding to the second version of the executable load file; and
providing a second application instance access to the first static resource that is comprised within the memory of the secure element hardware platform, the second application instance corresponding to the second version of the executable load file,
wherein the method is performed by at least one device including a hardware processor.

10. The method of claim 9:
wherein initiating the upgrade process is responsive to the secure element hardware platform receiving the upgrade command; and
wherein providing the second application instance access to the first static resource is based on at least one of (a) the upgrade command comprising instructions to provide the second application instance access to the first static resource or (b) a request, by the second application instance, for access to the first static resource.

11. The method of claim 9, further comprising:
prior to providing the second application instance access to the first static resource:
based, at least in part, on the second set of one or more resources corresponding to the second version of the executable load file, initializing the second application instance on the secure element hardware platform; and
receiving, from the second application instance, a second request for access to the first static resource, wherein providing the second application instance access to the first static resource is responsive to receiving the second request.

12. The method of claim 11:
wherein discarding the first set of one or more resources corresponding to the first version of the executable load file comprises:
discarding a second static resource of the first version of the executable load file from the memory of the secure element hardware platform based on at least one of (a) the upgrade command not comprising instructions to retain the second static resource in the memory of the secure element hardware platform for at least part of the upgrade process or (b) one or more application instances corresponding to the first version of the executable load file not requesting that the second static resource be retained in the memory of the secure element hardware platform for at least part of the upgrade process; and
discarding the first application instance from the memory of the secure element hardware platform; and
wherein storing the second set of one or more resources corresponding to the second version of the executable load file comprises:
storing, in the memory of the secure element hardware platform, a third static resource of the second version of the executable load file to replace the second static resource of the first version of the executable load file.

13. The method of claim 9:
wherein identifying the first static resource is based on the upgrade command comprising the instructions to retain the first static resource in the memory of the secure element hardware platform;
wherein the first set of one or more resources comprises a second static resource of the first version of the executable load file;
wherein the second set of one or more resources comprises a third static resource of the second version of the executable load file to replace the second static resource of the first version of the executable load file; and
wherein providing the second application instance access to the first static resource is based on the upgrade command comprising instructions for providing the second application instance access to the first static resource.

14. The method of claim 13:
wherein the upgrade command comprises instructions for skipping one or more steps of the upgrade process;
wherein the first application instance is prevented from creating the first request based on the upgrade command comprising the instructions for skipping the one or more steps of the upgrade process;
wherein the first set of one or more resources does not comprise the first application instance; and
wherein the first application instance is the second application instance.

15. The method of claim 9, further comprising:
based on the upgrade command comprising instructions for preventing one or more static resources corresponding to the first version of the executable load file from being retained in the memory of the secure element hardware platform, performing at least one of:
(a) prior to discarding the first set of one or more resources corresponding to the first version of the executable load file, declining a second request, by the first application instance, to retain a second static resource of the first version of the executable load file in the memory of the secure element hardware platform for at least part of the upgrade process, wherein the first set of one or more resources comprises the second static resource; or
(b) subsequent to discarding the first set of one or more resources corresponding to the first version of the executable load file, declining a third request, by the second application instance, for access to a third static resource of the first version of the executable load file that is comprised within the memory of the secure element hardware platform.

16. The method of claim 9:
wherein the first version of the executable load file is a first version of a converted applet (CAP) file;
wherein the second version of the executable load file is a second version of the CAP file; and
wherein providing the second application instance access to the first static resource comprises one of:
(a) if the second set of one or more resources does not comprise at least one static resource, creating, by the secure element hardware platform, a static resource component for the second version of the CAP file, the static resource component comprising the first static resource; or
(b) if the second set of one or more resources comprises at least one static resource, modifying, by the secure element hardware platform, the static resource component of the second version of the CAP file to comprise the first static resource.

17. A system comprising:
one or more hardware processors;
one or more non-transitory computer-readable media; and
program instructions stored on the one or more non-transitory computer-readable media that, when executed by the one or more hardware processors, cause operations comprising:
initiating an upgrade process for upgrading an executable load file stored in memory of a secure element hardware platform from a first version of the executable load file into a second version the executable load file;
identifying a first static resource of the first version of the executable load file that is to be retained in the memory of the secure element hardware platform for at least part of the upgrade process based on at least one of (a) an upgrade command comprising instructions to retain the first static resource in the memory of the secure element hardware platform for at least part of the upgrade process or (b) a first request, by a first application instance, to retain the first static resource in the memory of the secure element hardware platform for at least part of the upgrade process, the first application instance corresponding to the first version of the executable load file;
discarding, from the memory of the secure element hardware platform, a first set of one or more resources corresponding to the first version of the executable load file, wherein the first set of one or more resources does not comprise the first static resource;
storing, in the memory of the secure element hardware platform, a second set of one or more resources corresponding to the second version of the executable load file; and
providing a second application instance access to the first static resource that is comprised within the memory of the secure element hardware platform, the second application instance corresponding to the second version of the executable load file.

18. The system of claim 17:
wherein initiating the upgrade process is responsive to the secure element hardware platform receiving the upgrade command; and
wherein providing the second application instance access to the first static resource is based on at least one of (a) the upgrade command comprising instructions to provide the second application instance access to the first static resource or (b) a request, by the second application instance, for access to the first static resource.

19. The system of claim 17, wherein the operations further comprise:
prior to providing the second application instance access to the first static resource:
based, at least in part, on the second set of one or more resources corresponding to the second version of the executable load file, initializing the second application instance on the secure element hardware platform; and
receiving, from the second application instance, a second request for access to the first static resource, wherein providing the second application instance access to the first static resource is responsive to receiving the second request.

20. The system of claim 19:
wherein discarding the first set of one or more resources corresponding to the first version of the executable load file comprises:
discarding a second static resource of the first version of the executable load file from the memory of the secure element hardware platform based on at least one of (a) the upgrade command not comprising instructions to retain the second static resource in the memory of the secure element hardware platform for at least part of the upgrade process or (b) one or more application instances corresponding to the first version of the executable load file not requesting that the second static resource be retained in the memory of the secure element hardware platform for at least part of the upgrade process; and
discarding the first application instance from the memory of the secure element hardware platform; and
wherein storing the second set of one or more resources corresponding to the second version of the executable load file comprises:
storing, in the memory of the secure element hardware platform, a third static resource of the second version of the executable load file to replace the second static resource of the first version of the executable load file.
